(19) United States
(12) Patent Application Publication
(10) Pub. No.: US 2022/0087323 A1
(43) Pub. Date: Mar. 24, 2022

(54) AEROSOL GENERATING APPARATUS, AEROSOL GENERATING ARTICLE AND METHOD OF DETERMINING DATA ASSOCIATED WITH AN AEROSOL GENERATING ARTICLE

(71) Applicant: Nicoventures Trading Limited, London (GB)

(72) Inventors: Patrick MOLONEY, London (GB); Anton KORUS, London (GB); Justin Han Yang CHAN, London (GB)

(21) Appl. No.: 17/310,139

(22) PCT Filed: Jan. 23, 2020
(86) PCT No.: PCT/EP2020/051665

§ 371 Date: Jul. 20, 2021

(30) Foreign Application Priority Data
Jan. 25, 2019 (GB) 1901066.9

(51) Int. Cl. A24F 40/53; A24F 40/51; A24F 40/20; A24D 1/20; G06K 19/06

(52) U.S. Cl. CPC A24F 40/53; A24F 40/51; G06K 19/06018; A24D 1/20; A24F 40/20

(57) ABSTRACT

An aerosol generating apparatus is provided. The apparatus comprises a chamber configured to receive an article comprising an aerosolizable medium, a sensor arrangement configured to detect a first marker arrangement on the article and a second marker arrangement on the article. The second marker arrangement is located at a predetermined position relative to the first marker arrangement. The apparatus further comprises a controller, configured to determine a plurality of comparison values by comparing a plurality of first marker regions in the first marker arrangement with the second marker arrangement, and determine data associated with the article based on the plurality of comparison values.

### PRIORITY CLAIM

The present application is a National Phase entry of PCT Application No. PCT/EP2020/051665, filed Jan. 23, 2020, which claims priority from Great Britain Application No. 1901066.9, filed Jan. 25, 2019, each of which is hereby fully incorporated herein by reference.

### TECHNICAL FIELD

The present invention relates to an aerosol generating apparatus, an aerosol generating article, an aerosol generating system, and to a method of determining data associated with an aerosol generating article.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to a first aspect of the present disclosure, there is provided an aerosol generating apparatus comprising: a chamber configured to receive an article comprising an aerosolizable medium, and a sensor arrangement configured to detect a first marker arrangement on the article and a second marker arrangement on the article. The second marker arrangement is located at a predetermined position relative to the first marker arrangement. The aerosol generating article further comprises a controller, configured to determine a plurality of comparison values by comparing a plurality of first marker regions in the first marker arrangement with the second marker arrangement and determine data associated with the article based on the plurality of comparison values.

According to a second aspect of the present disclosure, there is provided an aerosol generating article, comprising an aerosolizable medium, a first marker arrangement comprising a plurality of first marker regions, and a second marker arrangement. The first marker arrangement is positioned at a predetermined position relative to the second marker arrangement, such that a comparison of the first marker arrangement with the second marker arrangement is indicative of data associated with the aerosol generating article.

According to a third aspect of the present disclosure, there is provided a system, comprising an aerosol generating apparatus according to the first aspect, and an aerosol generating article according to the second aspect.

According to a fourth aspect of the present disclosure, there is provided a method of determining data associated with an aerosol generating article, the method comprising: detecting the presence of a first marker arrangement on the article, the first marker arrangement comprising a plurality of first marker regions; detecting the presence of a second marker arrangement on the article, wherein the second marker arrangement is located at a predetermined position relative to the first marker arrangement; comparing the plurality of first marker regions with the second marker arrangement, to determine a plurality of comparison values; and determining the data based on the plurality of comparison values.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a perspective view of an example of an aerosol generating apparatus;

FIG. 2 shows a top view of the example aerosol generating apparatus of FIG. 1;

FIG. 3 shows a cross-sectional view of the example aerosol generating apparatus of FIG. 1;

FIG. 4 shows an aerosol generating article, according to an example;

FIG. 5 shows an aerosol generating article, according to a second example;

FIG. 6 shows an aerosol generating article, according to a third example;

FIG. 7 shows an aerosol generating article, according to a fourth example; and

FIG. 8 shows a flow diagram of a method of determining data associated with an aerosol generating article in accordance with an example.

### DETAILED DESCRIPTION OF THE DRAWINGS

A first aspect of the present disclosure defines an aerosol generating apparatus comprising a chamber which can receive an article comprising an aerosolizable medium, such as tobacco, for heating. A user may insert the article into the aerosol generating apparatus before it is heated to produce an aerosol, which the user subsequently inhales. The article may be, for example, of a predetermined or specific size that is configured to be placed within the heating chamber which is sized to receive the article. In one example, the article is tubular in nature, and may be known as a “tobacco stick”, for example, the aerosolizable medium may comprise tobacco formed in a specific shape which is then coated, or wrapped in one or more other materials, such as paper or foil. In another example, the article may be a flat substrate. The aerosolizable medium may also be known as smokable material or an aerosolizable material.

It may be desirable for the apparatus to be able to identify or recognize the particular article that has been introduced into the apparatus, without further input from the user. For example, the apparatus may be optimized for a particular type of article (e.g. one or more of size, shape, particular aerosolizable material, etc.). It may be undesirable for the apparatus to be used with an article having different characteristics. If the apparatus could identify or recognize the particular article, or at least the general type of article, that has been introduced into the apparatus, this can help eliminate or at least reduce counterfeit or other non-genuine articles being used with the apparatus. In addition, it may be desirable to identify the particular article so that the apparatus can be operated in a manner suitable for the particular article. For example, a specific heating temperature, profile or length may be selected for the specific article introduced into the heating chamber.

A detector/sensor may be used to detect a single identification code, such as a barcode, present on the article. The detector reads the code as a user inserts the article into the device. However, with single identification codes it is often difficult to read the code as the user inserts the article into the apparatus. Features within the barcode can become unresolvable from one another due to the movement of the article. For example, the detector may fail to accurately read a barcode printed on the article if it moves past a detector too quickly. There is therefore a need for an aerosol generating apparatus and article having an identification code which can be read more reliably.

Accordingly, an example aerosol generating apparatus described herein comprises a sensor arrangement and a controller configured to read a specific marker arrangement located on an example aerosol generating article. The sensor arrangement is configured to detect a first marker arrangement on the article and a second marker arrangement on the article. The second marker arrangement is located at a predetermined position relative to the first marker arrangement. The controller is configured to determine a plurality of comparison values by comparing a plurality of first marker regions in the first marker arrangement with the second marker arrangement, and determine data associated with the article based on the plurality of comparison values. The data may, for example, indicate the type of consumable being inserted.

By comparing the plurality of first marker regions with the second marker arrangement, data associated with the article can be determined independent of the rate of insertion. This is because both marker arrangements are moving together at the same rate, and the comparison of these two marker arrangements leads to the controller determining the data associated with the article. It should be appreciated that while this approach has benefits when the rate of insertion is variable, this approach may also be used in implementations where the rate of insertion is constant (e.g., where an article is moved via automated means). In addition, it should be understood that the present technology is not limited to cases where the article is inserted into a device, but more broadly relates to a moving article, e.g., in cases where the article is already inserted in the device but is subsequently moved while held within the article.

Similarly, an example aerosol generating article described herein comprises an aerosolizable medium, a first marker arrangement comprising a plurality of first marker regions and a second marker arrangement. The first marker arrangement is positioned at a predetermined position relative to the second marker arrangement, such that a comparison of the first marker arrangement with the second marker arrangement is indicative of data associated with the aerosol generating article.

In some examples, the second marker arrangement also comprises a plurality of second marker regions, such that a comparison of the plurality of first marker regions with the plurality of second marker regions is indicative of the data associated with the aerosol generating article. The controller may therefore be configured to determine the plurality of comparison values by comparing the plurality of first marker regions in the first marker arrangement with a plurality of second marker regions in the second marker arrangement. By having a plurality of first and second marker regions, more data may be encoded within the marker arrangements.

The marker regions may be compared on a one:one basis, for example where a marker region in the first arrangement is compared with a corresponding marker region in the second arrangement. The marker regions may be compared on a one:many basis, for example where a marker region in one arrangement is compared to a plurality of marker regions in the other arrangement. The marker regions may be compared on a many:many basis, for example where a plurality of marker regions in first arrangement are compared as whole with a plurality of marker regions in the second arrangement.

The controller may be configured to compare the plurality of first marker regions with the plurality of second marker regions to determine a plurality of comparison values may comprise the controller being configured to determine the plurality of comparison values based on whether the plurality of second marker regions comprise second markers.

Thus, in some examples, some or all of the plurality of second marker regions may comprise markers within them. Those regions without second markers may be “empty” or blank. Accordingly, the sensor arrangement may detect one or more second markers within the second marker arrangement. From here, comparison values can be determined. In a specific example, the plurality of first marker regions each represent a bit value in a string of bits. Should the corresponding second marker region comprise a second marker, the comparison value may read “1” for example, and should the corresponding second marker region not comprise a second marker, the comparison value may read “0”. In this way, a plurality of comparison values may be detected. The full bit sequence from a comparison of markers may be indicative of data associated with the article.

In another specific example, the plurality of first marker regions may each represent a letter, such as a letter which forms part of a string of letters. Should the corresponding second marker region comprise a second marker, the comparison value may be represented by the letter of the corresponding first marker region. Should the corresponding second marker region not comprise a second marker, the comparison value may be blank.

In an alternative example, each of the plurality of second marker regions may comprise a second marker, and each of the plurality of first marker regions may comprise a corresponding first marker. Positions of the second markers relative to positions of the corresponding first markers may be indicative of the data. Accordingly, the controller being configured to compare the plurality of first marker regions with the plurality of second marker regions to determine a plurality of comparison values may comprise the controller being configured to determine the plurality of comparison values based on positions of second markers located in the plurality of second marker regions, relative to corresponding first markers located in the plurality of first marker regions. Accordingly, the sensor arrangement may detect the position of each second marker relative to the position of a corresponding first marker. From here, comparison values can be determined based on the relative positioning.

The plurality of first marker regions may be arranged adjacent to each other along a marker axis, and the plurality of second marker regions may be offset from the plurality of first marker regions in a direction perpendicular to the marker axis. The positions of the second markers along the marker axis relative to positions of the corresponding first markers along the marker axis may be indicative of the data. Accordingly, the controller being configured to determine the plurality of comparison values based on the positions may comprise the controller being configured to either (i) determine that a second marker is arranged further along a marker axis in a first direction than a corresponding first marker, and responsively determine that the comparison value is a first comparison value, or (ii) determine that the corresponding first marker is arranged further along the marker axis in the first direction than the second marker, and responsively determine that the comparison value is a second comparison value, the second comparison value being different to the first comparison value.

The marker axis may be an axis defined by either the first marker arrangement or the second marker arrangement. For example, the plurality of first marker regions may be arranged adjacent to each other in a row, where the row defines the marker axis. The second marker regions may be arranged parallel to the marker axis.

In a specific example, the plurality of first marker regions represent a bit value in a sequence of bits, and the plurality of second marker regions correspond to the plurality of first marker regions. For each of the plurality of second marker regions, the position of the second marker is compared to a position of a corresponding first marker in the corresponding first marker region. If the second marker is situated further along the marker axis in a particular direction than the corresponding first marker, the comparison value may read “1” for example. Conversely, if the first marker is situated further along the marker axis in the particular direction than the corresponding second marker, the comparison value may read “0” for example. In this way, a plurality of comparison values may be detected. At least part of the bit sequence from the comparison of markers may therefore be indicative of data associated with the article.

The chamber may define an insertion axis along which the article is insertable/receivable in the chamber, and the marker axis and the insertion axis may be parallel when the article is inserted/received in the aerosol generating apparatus. Accordingly, the first and second marker arrangements may be aligned with the chamber when the article is being inserted into the chamber. This alignment can reduce the number of sensors required within the aerosol generating apparatus because the movement of the article past the sensor arrangement allows each of the marker regions to be read. If the axes are not aligned, more sensors, or sensors with a wider field of view may be required.

The sensor arrangement may comprise a first sensor configured to detect the first marker arrangement, and a second sensor configured to detect the second marker arrangement. The use of two sensors may simplify processing of the different marker arrangements. For example, if they are optical sensors, then fewer processing steps may be needed to sense the different regions within the image.

The sensors may sense electromagnetic radiation reflected or produced by the first and second marker arrangements. For example, the sensors may be optical sensors and may detect light reflected from the marker arrangements. In other examples, the sensors may be capacitance sensors, where a change in capacitance allows the marker arrangements to be read. In some examples, the first and second marker arrangements are printed, etched, or coated on the article. The first and second marker arrangements may be visible or invisible to the human eye.

The controller may further be configured to activate the second sensor responsive to the first sensor detecting the presence of the first marker arrangement. By only activating the second sensor after the first sensor has detected the first marker arrangement, power can be saved. For example, only the first sensor need check for the presence of the first marker arrangement.

The controller may further be configured to deactivate the second sensor responsive to the second sensor detecting the presence of the second marker arrangement. Thus, once the second marker arrangement has been detected, the second sensor may be powered off to save energy. The first sensor may remain powered on.

In some examples, the sensor arrangement comprises a sensor configured to detect the first marker arrangement and the second marker arrangement. Thus, instead of having two or more sensors, a single sensor may read both marker arrangements. This may be desirable to make the apparatus less expensive to produce. The apparatus may be lighter and/or more compact by having only a single senor. A single sensor may also simplify operation because the two separate sensors do not need to be synchronized to operate, and the sensor data may be analyzed from a single set of sensor data.

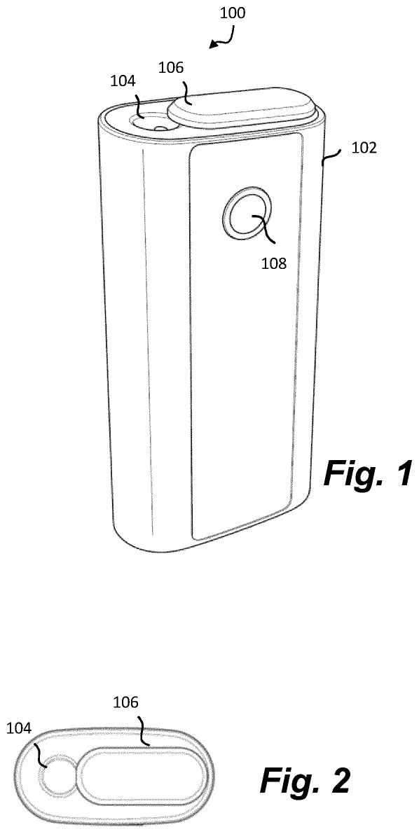

FIG. 1 shows an example of an apparatus 100 for generating aerosol from an aerosolizable medium. The device 100 may also be known as an aerosol provision device. In broad outline, the apparatus 100 may be used to heat a replaceable article (not shown) comprising an aerosolizable medium, to generate an aerosol or other inhalable medium which is inhaled by a user of the apparatus 100. FIG. 2 shows a top view of the example of the apparatus 100 shown in FIG. 1.

The apparatus 100 comprises a housing 102 which houses the various components of the apparatus 100. The housing 102 has an opening 104 in one end, through which the article may be inserted into a heating chamber (not shown). In use, the article may be fully or partially inserted into the chamber. The heating chamber may be heated by one or more heating elements (not shown). The apparatus 100 may also comprise a lid, or cap 106, to cover the opening 104 when no article is in place. In FIGS. 1 and 2, the cap 106 is shown in an open configuration, however the cap 106 may move, for example by sliding, into a closed configuration. The apparatus 100 may include a user-operable control element 108, such as a button or switch, which operates the apparatus 100 when pressed.

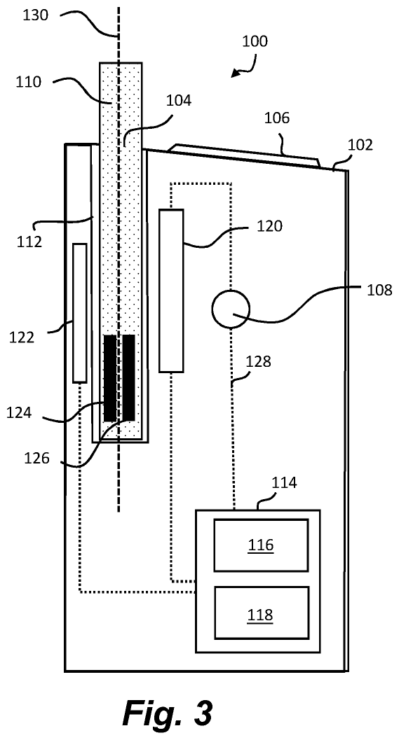

FIG. 3 shows a cross-sectional view of an example of an apparatus 100 as shown in FIG. 1. The apparatus 100 has a receptacle, or chamber 112 which is configured to receive an article 110 to be heated. In one example, the heating chamber 112 is generally in the form of a hollow cylindrical tube into which an article 100 comprising aerosolizable medium is inserted for heating in use. However, different arrangements for the heating chamber 112 are possible. In the example of FIG. 3, an article 110 comprising aerosolizable medium has been inserted into the heating chamber 112. The article 110 in this example is an elongate cylindrical rod, although the article 110 may take any suitable shape. In this example, an end of the article 110 projects out of the apparatus 100 through the opening 104 of the housing 102 such that user may inhale the aerosol through the article 110 in use. The end of the article projecting from the apparatus 100 may include a filter material. In other examples the article 110 is fully received within the heating chamber 112 such that it does not project out of the apparatus 100. In such a case, the user may inhale the aerosol directly from the opening 104, or via a mouthpiece which may be connected to the housing 102 around the opening 104.

The apparatus 100 comprises one or more aerosol generating elements. In one example, the aerosol generating elements are in the form of a heater arrangement 120 arranged to heat the article 110 located within the chamber 112. In one example the heater arrangement 120 comprises resistive heating elements that heat up when an electric current is applied to them. In other examples, the heater arrangement 120 may comprise a susceptor material that is heated via induction heating. In the example of the heater arrangement 120 comprising a susceptor material, the apparatus 100 also comprises one or more induction elements which generate a varying magnetic field that penetrate the heater arrangement 120. The heater arrangement may be located internally or externally of the heating chamber 112. In one example, the heater arrangement may comprise a thin film heater that is wrapped around an external surface of the heating chamber 112. For example, the heater arrangement 120 may be formed as a single heater or may be formed of a plurality of heaters aligned along the longitudinal axis of the heating chamber 112. The heating chamber 112 may be annular or tubular, or at least part-annular or part-tubular around its circumference. In one particular example, the heating chamber 112 is defined by a stainless steel support tube. The heating chamber 112 is dimensioned so that substantially the whole of the aerosolizable medium in the article 110 is located within the heating chamber 112, in use, so that substantially the whole of the aerosolizable medium may be heated. In other examples, the heater arrangement 120 may include a susceptor that is located on or in the article 110, wherein the susceptor material is heatable via a varying magnetic field generated by the apparatus 100. The heating chamber 112 may be arranged so that selected zones of the aerosolizable medium can be independently heated, for example in turn (over time) or together (simultaneously), as desired.

In some examples, the apparatus 100 includes an electronics compartment 114 that houses electrical control circuitry or controller 116 and/or a power source 118, such as a battery. In other examples, a dedicated electronics compartment may not be provided and the controller 116 and power source 118 are located generally within the apparatus 100. The electrical control circuitry or controller 116 may include a microprocessor arrangement, configured and arranged to control the heating of the aerosolizable medium.

The power source 118 may be, for example, a battery, such as a rechargeable battery or a non-rechargeable battery. Examples of suitable batteries include, for example, a lithium-ion battery, a nickel battery (such as a nickel-cadmium battery), an alkaline battery and/or the like. The battery is electrically coupled to the one or more heaters to supply electrical power when required and under control of the controller 116 to heat the aerosolizable medium without causing the aerosolizable medium to combust. Locating the power source 118 adjacent to the heater arrangement 120 means that a physically large power source 118 may be used without causing the apparatus 100 as a whole to be unduly lengthy. As will be understood, in general a physically large power source 118 has a higher capacity (that is, the total electrical energy that can be supplied, often measured in Amp-hours or the like) and thus the battery life for the apparatus 100 can be longer.

The apparatus 100 includes a sensor arrangement 122 configured to detect a first marker arrangement 124 on the article 110 and to detect a second marker arrangement 126 on the article 110, as discussed further below.

In some examples, the controller 116 is configured to receive one or more inputs/signals from the sensor arrangement 122. The controller 116 may also receive a signal from the control element 110 and activate the heater arrangement 120 in response to the received signal and the received inputs. Electronic elements within the apparatus 100 may be electrically connected via one or more connecting elements 128, shown depicted as dashed lines.

As briefly mentioned above, it is sometimes desirable for the apparatus 100 to be able to identify or recognize the particular article 110 that has been introduced into the apparatus 100. For example, the apparatus 100, including, in particular, the heating control provided by the controller 116, will often be optimized for a particular arrangement of the article. It would be undesirable for the apparatus 100 to be used with an aerosolizable medium or an article 110 having different characteristics.

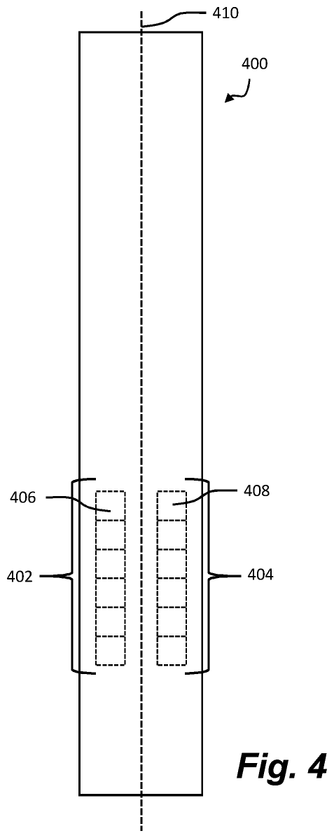

FIG. 4 depicts an aerosol generating article 400 according to an example. The article 400 defines a longitudinal axis 410 and comprises an aerosolizable medium, such as tobacco. A first marker arrangement 402 and a second marker arrangement 404 may be present on the article. In this example, the marker arrangements 402, 404 are aligned parallel to the longitudinal axis 410, however other alignments are possible. The first marker arrangement may comprise a plurality of first marker regions 406 and the second marker arrangement may also comprise a plurality of second marker regions 408. In some examples, however, the second marker arrangement 404 may comprise only a single second marker region 408. The first and second marker regions may occupy an area within their respective marker arrangement. For example, a marker region may be a section within the marker arrangement which is read by a sensor. The dashed lines depict an area occupied by the first and second marker regions 406, 408 to assist understanding, these dashed lines may not be present in some embodiments.

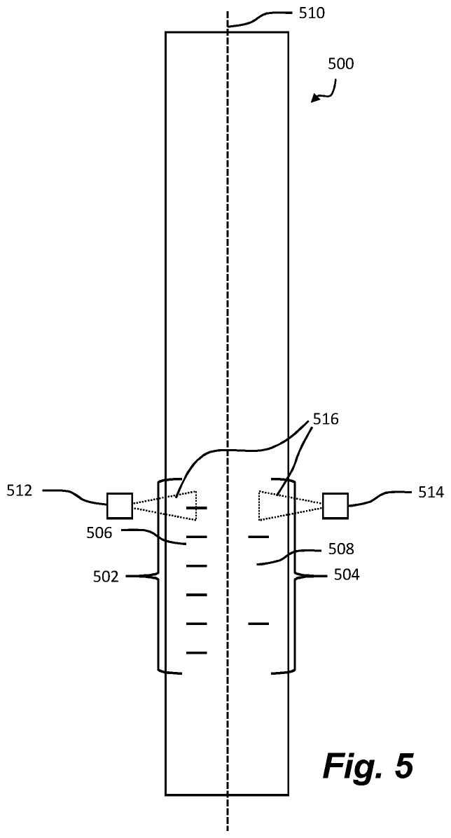

Markers may be located within the area occupied by the marker regions 406, 408 so that they can be detected by a sensor arrangement. In the example of FIG. 4, the marker regions 406, 408 are “empty” so would not yet be detectable. FIGS. 5-7 depict detectable marker regions 406, 408 in accordance with specific examples. The marker arrangements 402, 404, or features of the marker arrangements, may be printed, etched, or coated onto the article 400. For example, in the example where the article 400 is a rod of tobacco, the marker arrangements 402, 404 may be printed onto paper which surrounds the tobacco.

As is shown in FIG. 4, the first marker arrangement 402 is positioned at a predetermined position relative to the second marker arrangement 404. In broad terms, once detected by a sensor arrangement, such as the sensor arrangement 122 depicted in FIG. 3, a comparison of the first marker arrangement 402 with the second marker arrangement 404 may be indicative of data associated with the aerosol generating article 400. For example, the data may comprise a plurality of values, and the plurality of values can be determined by comparing the plurality of first marker regions 406 in the first marker arrangement 402 with the second marker arrangement 404. Or more particularly, the plurality of values may be determined by comparing the plurality of first marker regions 406 in the first marker arrangement 402 with a plurality of second marker regions 408 in the second marker arrangement 404.

FIG. 5 depicts an aerosol generating article 500 according to a first example. In this example, markers are present within some or all of the marker regions. The article 500 defines a longitudinal axis 510. The article 500 comprises a first marker arrangement 502 and a second marker arrangement 504. The first marker arrangement comprises a plurality of first marker regions 506 and the second marker arrangement also comprises a plurality of second marker regions 508.

FIG. 5 depicts each of the first marker regions 506 comprising a first marker, shown depicted as a horizontal line. The presence of the first markers indicate the first marker region 506. Thus, each first marker region 506 may be detected by a sensor arrangement by detecting the presence of a first marker. The first markers may take any suitable form, to ensure that it may be detected by a sensor arrangement. Each of the first marker regions 506 are arranged adjacent to a corresponding second marker region 508. Some, or all of the second marker regions 508 comprise second markers, again depicted as horizontal lines. Those second marker regions 508 not comprising second markers may be empty, or they may comprise a different distinguishable marker.

To determine data associated with the article, the plurality of first marker regions 506 in the first marker arrangement 502 can be compared with a plurality of second marker regions 508 in the second marker arrangement 504. The presence, or absence of the second markers within each of the second marker regions 508 may be indicative of a value. Together, these values form data associated with the article.

In the Example of FIG. 5, the number of first marker regions 506 indicate the length of an identification code. The identification code is represented as data. Thus, in the example, the identification code comprises six values. The individual values may be represented as numbers, letters, or any other indicia. In the example of FIG. 5, however, each value is represented as a bit-value, i.e. either a “1” or a “0”. Should the corresponding second marker region 508 comprise a second marker, the value may read “1” for example, and should the corresponding second marker region not comprise a second marker, the value may read “0”. In this way, a plurality of comparison values may be detected. In the example of FIG. 5, the uppermost second marker region 508 does not comprise a second marker. Thus, the value of this row may be “0”. The next second marker region 508 below this does comprise a second marker, so the value may be “1”. The next two second marker regions 508 do not comprise second markers, so both values may be “0”. The second to last second marker region 508 does comprise a second maker, so the value may be “1”. The bottom second marker region 508 does not comprise a second marker, so the value may be “0”. Thus, the plurality of values read: “0,1,0,0,1,0”. The plurality of values may be known as comparison values because they are determined by detecting, and therefore comparing, both the first and second marker arrangements 502, 504 relative to one another. The specific type of article 500 may therefore be detected by reading the data “0,1,0,0,1,0”. The data may indicate that the article 500 is manufactured by a specific company or in a specific location, and/or that it requires heating for a certain length of time, for example.

FIG. 5 depicts a sensor arrangement comprising a first sensor 512 and a second sensor 514. Signals from the sensors 512, 514 can be transmitted to a controller, such as controller 116 depicted in FIG. 3. The sensor data can be processed to determine the comparison values and therefore the data associated with the article 500. The first sensor 512 is configured to detect the first marker arrangement 502 and the second sensor 514 configured to detect the second marker arrangement 504. In other examples however, a single sensor may detect both the first and second marker arrangements 502, 504. The sensors 512, 514 each have a specific field of view 516. As a user inserts the article 500 into the apparatus 100, the marker regions 506, 508 pass through the field of view 516, which allows the first and second markers to be detected.

In one example, only one of the sensors 512, 514 may be active to detect the presence of a marker arrangement. The other sensor may be activated as the active sensor initially detects the presence of a marker arrangement. For example, the first sensor 512 may be active and after initially detecting the presence of the first marker arrangement 502, a signal is sent to activate the second sensor 514. The second sensor 514 may later be deactivated after a predetermined period and/or responsive to the second sensor 514 having detected the presence of the second marker arrangement 504. By operating in this way, the apparatus 100 can be more energy efficient because both sensors do not need to be active all the time.

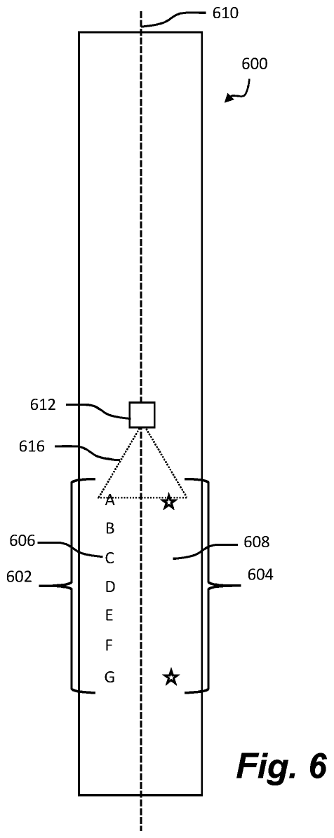

FIG. 6 depicts an aerosol generating article 600 according to a second example. In this example, markers are present within some or all of the marker regions. The article 600 defines a longitudinal axis 610. The article 600 comprises a first marker arrangement 602 and a second marker arrangement 604. The first marker arrangement comprises a plurality of first marker regions 606 and the second marker arrangement also comprises a plurality of second marker regions 608.

FIG. 6 depicts each of the first marker regions 606 comprising a first marker, shown depicted as, or representing, letters. Each first marker region 606 may be detected by a sensor arrangement by detecting the presence of a first marker. Each of the first marker regions 606 are arranged adjacent to a corresponding second marker region 608. As is shown, some, or all of the second marker regions 608 comprise second markers, shown depicted as a star shape. Those second marker regions 608 not comprising second markers may be empty, or they may comprise a different distinguishable marker.

To determine data associated with the article, the plurality of first marker regions 606 in the first marker arrangement 602 can be compared with a plurality of second marker regions 608 in the second marker arrangement 604. The presence, or absence of the second markers within each of the second marker regions 608 may be indicative of a value. Together, these values form data associated with the article.

In the Example of FIG. 6, the number of first marker regions 606 indicate the length of an identification code. The identification code is represented as data. Thus, in the example, the identification code comprises seven values. The individual values may be represented as any indicium. In the example of FIG. 6, each value is represented as a letter of the alphabet. Should the corresponding second marker region 608 comprise a second marker, the value may represent the letter indicated by the corresponding first marker region 606. Should the corresponding second marker region not comprise a second marker, there may be no value. In this way, one or more comparison values may be detected.

In the example of FIG. 6, the uppermost second marker region 608 comprises a second marker. Thus, the value may be “A”. The next five marker regions 608 below this do not comprise a second maker, so no value is determined. Alternatively, a special value may be determined, such as a “0” or “−” to indicate no second marker is present. The last second marker region 608 comprises a second marker, so the value may be “G”. Thus, the plurality of values read: “A,G” or “A,0,0,0,0,0,G” for example. The plurality of values may be known as comparison values because they are determined by detecting, and therefore comparing, both the first and second marker arrangements 602, 604. The specific type of article 600 may therefore be detected by reading the data “A,G”. The data may indicate that the article 600 is manufactured by a specific company or at a specific location, and/or that it requires heating to a certain temperature for example.

FIG. 6 depicts a sensor arrangement comprising a sensor 612. Signals from the sensor 612 can be transmitted to a controller, such as controller 116 depicted in FIG. 3. The sensor 612 is configured to detect the first marker arrangement 602 and the second marker arrangement 604. In other examples however, two or more sensors may detect the first and second marker arrangements 602, 604. The sensor 612 has a specific field of view 616 capable of sensing both the first and second sensor arrangements 602, 604. As a user inserts the article 600 into the apparatus 100, the marker regions 606, 608 pass through the field of view 616, which allows the first and second markers to be detected.

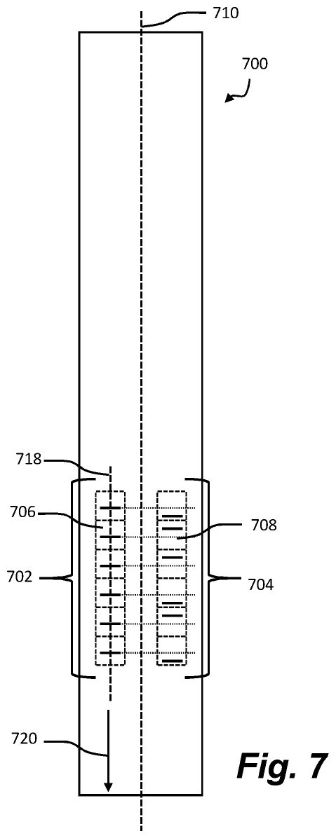

FIG. 7 depicts an aerosol generating article 700 according to a third example. In this example, markers are present within all of the marker regions. The article 700 defines a longitudinal axis 710. The article 700 comprises a first marker arrangement 702 and a second marker arrangement 704. The first marker arrangement comprises a plurality of first marker regions 706 and the second marker arrangement also comprises a plurality of second marker regions 708. For illustrative purposes in this example, the areas bounded by the first and second marker regions 706, 708 are depicted with dashed lines. The boundaries of the first and second marker regions 706, 708 may or may not be printed on the article 700.

FIG. 7 depicts each of the first marker regions 706 comprising a first marker, shown depicted as a horizontal line. The presence of the first markers indicate the first marker region 706. Thus, each first marker region 706 may be detected by a sensor arrangement by detecting the presence of a first marker. The first markers may take any suitable form, to ensure that it may be detected by a sensor arrangement. Each of the first marker regions 706 are arranged adjacent to a corresponding second marker region 708. All of the second marker regions 708 comprise second markers, again shown depicted as horizontal lines. The first and second marker arrangements 702, 207 may be detected by a sensor arrangement like that described in relation to either FIG. 5 or 6.

To determine data associated with the article, the plurality of first marker regions 706 in the first marker arrangement 702 can be compared with a plurality of second marker regions 708 in the second marker arrangement 704. The positions of the second markers located in the second marker regions 708 relative to corresponding first markers located in the plurality of first marker regions 706 may indicate a particular value. Together, these values form data associated with the article.

In the Example of FIG. 7, the number of first marker regions 706 indicate the length of an identification code. The identification code is represented as data. Thus, in the example, the identification code comprises six values. The individual values may be represented as numbers, letters, or any other indicia. In the example of FIG. 7, however, each value is represented as a bit-value, i.e. either a “1” or a “0”.

The position of a second marker relative to the corresponding first marker determines whether the value should be a “1” or a “0”. FIG. 7 depicts a marker axis 718 which is defined by one or both of the marker arrangements 702, 704.

In this example, the value is a “1” if the second marker is arranged further along a marker axis 718 in a first direction 720 than a corresponding first marker. The value is a “0” if the first marker is arranged further along the marker axis 718 in the first direction 720 than the second marker. In this way, a plurality of comparison values may be detected.

In the example of FIG. 7, the uppermost second marker region 708 comprises a second marker which is offset/displaced further along the marker axis 718 in the first direction 720 than the corresponding first marker in the uppermost first marker region 706. Thus, the value may be “1”. In the next row of marker regions 706, 708 the first marker is offset/displaced further along the marker axis 718 in the first direction 720 than the corresponding second marker. Thus, the value is a “0”. In the third row of marker regions 706, 708 the first marker is offset/displaced further along the marker axis 718 in the first direction 720 than the corresponding second marker. Thus, the value is a “0”. In the fourth row of marker regions 706, 708, the second marker is offset/displaced further along the marker axis 718 in the first direction 720 than the corresponding first marker. Thus, the value is a “1”. In the fifth row of marker regions 706, 708 the first marker is offset/displaced further along the marker axis 718 in the first direction 720 than the corresponding second marker. Thus, the value is a “0”. In the bottom row of marker regions 706, 708 the second marker is offset/displaced further along the marker axis 718 in the first direction 720 than the corresponding first marker. Thus, the value is a “1”.

Accordingly, the plurality of values read: “1,0,0,1,0,1”. The plurality of values may be known as comparison values because they are determined by detecting, and therefore comparing, both the first and second marker arrangements 702, 704.

In FIG. 7, the marker axis 718 and the longitudinal axis 710 are parallel. In other examples, the marker axis 718 and the longitudinal axis 710 may be angled with respect to each other. In addition, the heating chamber 112 (depicted in FIG. 3) may define an insertion axis 130 along which the article 700 is receivable in the chamber 112. In a specific example, the marker axis 718 and the insertion axis 130 may be parallel when the article 700 is received in the aerosol generating apparatus. A user may therefore insert the article 700 in the first direction 720. By aligning the marker axis 718 and the insertion axis 130 in this way, the first and second marker arrangements 702, 704 can be read as they move past the sensor arrangement. If the axes 718, 130 were not aligned in this way, more sensors may be required to read the first and second marker arrangements 702, 704 around the insertion axis 130.

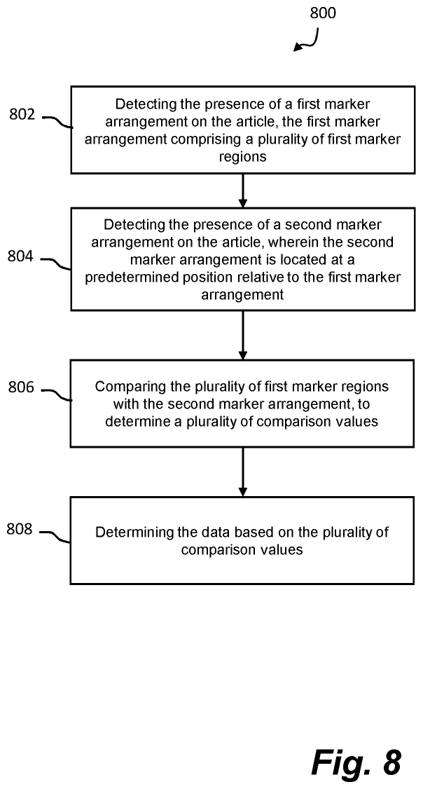

FIG. 8 shows a flow diagram of a method 800 for determining data associated with an aerosol generating article. At block 802, the method comprises detecting the presence of a first marker arrangement on the article, the first marker arrangement comprising a plurality of first marker regions. At block 804, the method comprises detecting the presence of a second marker arrangement on the article, wherein the second marker arrangement is located at a predetermined position relative to the first marker arrangement. At block 806, the method comprises comparing the plurality of first marker regions with the second marker arrangement, to determine a plurality of comparison values. At block 808, the method comprises determining the data based on the plurality of comparison values.

In some examples, the second marker arrangement comprises a plurality of second marker regions. Block 806 may therefore comprise comparing the plurality of first marker regions with the plurality of second marker regions.

In some examples, block 806 may comprise determining the plurality of comparison values based on whether the plurality of second marker regions comprise second markers.

In some examples, each of the plurality of second marker regions comprises a second marker, and each of the plurality of first marker regions comprises a corresponding first marker. Accordingly, block 806 may comprise determining the plurality of comparison values based on positions of the second markers relative to the corresponding first markers.

In some examples, the plurality of first marker regions are arranged adjacent to each other along a marker axis, and the plurality of second marker regions are offset from the plurality of first marker regions in a direction perpendicular to the marker axis. Determining the plurality of comparison values based on the positions comprises one of (i) determining that the second marker is arranged further along the marker axis in a first direction than the corresponding first marker, and responsively determining that the comparison value is a first comparison value, or (ii) determining that the corresponding first marker is arranged further along the marker axis in the first direction than the second marker, and responsively determining that the comparison value is a second comparison value, the second comparison value being different to the first comparison value.

The method may further comprise receiving the article in a chamber of an aerosol generating apparatus along an insertion axis, wherein the marker axis and the insertion axis are parallel when the article is received in the aerosol generating apparatus.

In some examples, detecting the presence of the first marker arrangement on the article comprises detecting the presence of the first marker arrangement on the article using a first sensor, and detecting the presence of the second marker arrangement on the article comprises detecting the presence of the second marker arrangement using a second sensor.

The method may further comprise activating the first sensor to detect the presence of the first marker arrangement and activating the second sensor responsive to detecting the presence of the first marker arrangement by the first sensor.

The method may further comprise, after detecting the second marker arrangement, deactivating the second sensor.

In some examples however, detecting the presence of the first marker arrangement on the article and the detecting the presence of the second marker arrangement on the article both use the same sensor.

In addition, while FIGS. 4 to 7 have generally shown the first marker region and the second marker region as being broadly in the same location relative to the longitudinal axis of the consumable, it should be appreciated that the first and second marker regions may be offset from one another in the direction of the longitudinal axis. For example, assuming the consumable has a distal end and a proximal end, the first marker region may be closer to the distal end than the proximal end, while the second marker region may be closer to the proximal end than the distal end. In this case, the marker regions are offset from one another by a predetermined distance and, provided that the corresponding sensors in the device are offset by the same or similar distance, the comparative values can still be obtained.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol generating apparatus comprising:
a chamber configured to receive an article comprising an aerosolizable medium;
a sensor arrangement configured to detect a first marker arrangement on the article and a second marker arrangement on the article, wherein the second marker arrangement is located at a predetermined position relative to the first marker arrangement; and
a controller, configured to:
determine a plurality of comparison values by comparing a plurality of first marker regions in the first marker arrangement with the second marker arrangement; and
determine data associated with the article based on the plurality of comparison values.

2. An aerosol generating apparatus according to claim 1, wherein the controller is configured to:
determine the plurality of comparison values by comparing the plurality of first marker regions in the first marker arrangement with a plurality of second marker regions in the second marker arrangement.

3. An aerosol generating apparatus according to claim 2, wherein the controller being configured to compare the plurality of first marker regions with the plurality of second marker regions to determine a plurality of comparison values comprises the controller being configured to:
determine the plurality of comparison values based on whether the plurality of second marker regions comprise second markers.

4. An aerosol generating apparatus according to claim 2, wherein the controller being configured to compare the plurality of first marker regions with the plurality of second marker regions to determine a plurality of comparison values comprises the controller being configured to:
determine the plurality of comparison values based on positions of second markers located in the plurality of second marker regions, relative to corresponding first markers located in the plurality of first marker regions.

5. An aerosol generating apparatus according to claim 4, wherein the controller being configured to determine the plurality of comparison values based on the positions comprises the controller being configured to, one of:
determine that a second marker is arranged further along a marker axis in a first direction than a corresponding first marker, and responsively determine that the comparison value is a first comparison value; and
determine that the corresponding first marker is arranged further along the marker axis in the first direction than the second marker, and responsively determine that the comparison value is a second comparison value, the second comparison value being different to the first comparison value.

6. An aerosol generating apparatus according to claim 5, wherein the chamber defines an insertion axis along which the article is receivable in the chamber, wherein the marker axis and the insertion axis are parallel when the article is received in the aerosol generating apparatus.

7. An aerosol generating apparatus according to any preceding claim, wherein the sensor arrangement comprises:
a first sensor configured to detect the first marker arrangement; and
a second sensor configured to detect the second marker arrangement.

8. An aerosol generating apparatus according to claim 7, wherein the controller is further configured to:
activate the second sensor responsive to the first sensor detecting the presence of the first marker arrangement.

9. An aerosol generating apparatus according to claim 8, wherein the controller is further configured to:
deactivate the second sensor responsive to the second sensor detecting the presence of the second marker arrangement.

10. An aerosol generating apparatus according to claim 1, wherein the sensor arrangement comprises:
a sensor configured to detect the first marker arrangement and the second marker arrangement.

11. An aerosol generating article, comprising:
an aerosolizable medium;
a first marker arrangement comprising a plurality of first marker regions; and
a second marker arrangement;
wherein the first marker arrangement is positioned at a predetermined position relative to the second marker arrangement, such that a comparison of the first marker arrangement with the second marker arrangement is indicative of data associated with the aerosol generating article.

12. An aerosol generating article according to claim 11, wherein the second marker arrangement comprises a plurality of second marker regions, such that a comparison of the plurality of first marker regions with the plurality of second marker regions is indicative of the data associated with the aerosol generating article.

13. An aerosol generating article according to claim 11, wherein relative positions of elements within the first marker arrangement and the second marker arrangement are indicative of the data.

14. An aerosol generating article according to claim 12, wherein each of the plurality of second marker regions comprises a second marker, and each of the plurality of first marker regions comprises a corresponding first marker, wherein positions of the second markers relative to positions of the corresponding first markers are indicative of the data.

15. An aerosol generating article according to claim 14, wherein the plurality of first marker regions are arranged adjacent to each other along a marker axis, and the plurality of second marker regions are offset from the plurality of first marker regions in a direction perpendicular to the marker axis, wherein the positions of the second markers along the marker axis relative to positions of the corresponding first markers along the marker axis are indicative of the data.

16. An aerosol generating article according to claim 15, wherein the article is insertable into a chamber of an aerosol generating apparatus along an insertion axis, wherein the marker axis and the insertion axis are parallel when the article is inserted into the aerosol generating apparatus.

17. (canceled)

18. A method of determining data associated with an aerosol generating article, the method comprising:
detecting the presence of a first marker arrangement on the article, the first marker arrangement comprising a plurality of first marker regions;
detecting the presence of a second marker arrangement on the article, wherein the second marker arrangement is located at a predetermined position relative to the first marker arrangement;
comparing the plurality of first marker regions with the second marker arrangement, to determine a plurality of comparison values; and
determining the data based on the plurality of comparison values.

19. A method according to claim 18, wherein the second marker arrangement comprises a plurality of second marker regions, and wherein the comparing the plurality of first marker regions with the second marker arrangement comprises:
comparing the plurality of first marker regions with the plurality of second marker regions.

20. A method according to claim 19, wherein the comparing the plurality of first marker regions with the plurality of second marker regions to determine a plurality of comparison values comprises:
determining the plurality of comparison values based on whether the plurality of second marker regions comprise second markers.

21. A method according to claim 19, wherein each of the plurality of second marker regions comprises a second marker, and each of the plurality of first marker regions comprises a corresponding first marker;
and wherein the comparing the plurality of first marker regions with the plurality of second marker regions to determine a plurality of comparison values, comprises:
determining the plurality of comparison values based on positions of the second markers relative to the corresponding first markers.

22. A method according to claim 21, wherein the plurality of first marker regions are arranged adjacent to each other along a marker axis, and the plurality of second marker regions are offset from the plurality of first marker regions in a direction perpendicular to the marker axis, wherein determining the plurality of comparison values based on the positions comprises one of:
determining that the second marker is arranged further along the marker axis in a first direction than the corresponding first marker, and responsively determining that the comparison value is a first comparison value; and
determining that the corresponding first marker is arranged further along the marker axis in the first direction than the second marker, and responsively determining that the comparison value is a second comparison value, the second comparison value being different to the first comparison value.

23. A method according to claim 22, further comprising:
receiving the article in a chamber of an aerosol generating apparatus along an insertion axis, wherein the marker axis and the insertion axis are parallel when the article is received in the aerosol generating apparatus.

24. A method according to claim 18, wherein:
detecting the presence of the first marker arrangement on the article comprises detecting the presence of the first marker arrangement on the article using a first sensor, and
detecting the presence of the second marker arrangement on the article comprises detecting the presence of the second marker arrangement using a second sensor.

25. A method according to claim 24, further comprising:
activating the first sensor to detect the presence of the first marker arrangement;
activating the second sensor responsive to detecting the presence of the first marker arrangement by the first sensor.

26. A method according to claim 25, further comprising, after detecting the second marker arrangement, deactivating the second sensor.

27. A method according to claim 18, wherein the detecting the presence of the first marker arrangement on the article and the detecting the presence of the second marker arrangement on the article both use the same sensor.
